(19) United States
(12) Patent Application Publication
(10) Pub. No.: US 2009/0049811 A1
(43) Pub. Date: Feb. 26, 2009

(54) Pocket Filter Joiner Arrangement and Method of Making

(76) Inventor: Kyung-Ju Choi, Louisville, KY (US)

Correspondence Address: MIDDLETON & REUTLINGER, 2500 BROWN & WILLIAMSON TOWER, LOUISVILLE, KY, 40202, US

(21) Appl. No.: 11/844,122

(22) Filed: Aug. 23, 2007

(51) Int. Cl. B01D 46/06; B65B 11/48

(52) U.S. Cl. 55/381; 156/70

(57) ABSTRACT

A filter bag, filter assembly, and method of making wherein the filter bag including a pair of longitudinally extending fluid pervious filter panels positioned in spaced opposed relation to form filter bag sides therebetween, the opposed longitudinally extending fluid pervious filter panels being connected together by at least one joiner in strip form arranged to extend longitudinally between the longitudinally extending spaced opposed filter panels and fastened on opposite longitudinal side edges of the joiner to the opposed panels from a downstream end to joiner separation points a selected distance from the upstream end.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF INVENTION

The present invention relates to a unique and novel pocket filter arrangement and method of manufacture, more particularly, to a pocket filter arrangement restricting pocket inflation and a method of manufacture incorporating existing manufacturing machinery.

### BACKGROUND OF THE INVENTION

Pocket filter assemblies are generally well known in the fluid or gas filtration art. Past assembly arrangements include one or more filter cartridges or filter bags that are secured across dirty fluid streams to be treated so that particulate materials are separated from such fluid streams as they flow through the filter media of the filter bags, the bags being replaced by fresh bags whenever necessary.

In such filter arrangements, it has proven desirable to minimize interfering contact between adjacent bags, to enhance fluid flow through the filter arrangements so as to effectively utilize a maximum of fluid filtering area with a minimum of fluid flow pressure loss and with a concomitant reduction of required operating energy. In U.S. Pat. No. 4,056,375, issued to W. Ringel et al. on Nov. 1, 1977, wedge-shaped, stiffened filter pockets, incorporating laminar spacing elements secured to the wedge faces of the pockets by fusion, have been utilized to separate dust particles from an air stream. The laminar spacing elements have been comparatively difficult to manufacture and assemble and have tended to interfere with air stream flow through the filtering area, limiting full use of the filtering area, with the methods of manufacture and machinery utilized being comparatively complex and unsuitable for maximizing filtration efficiency. In U.S. Pat. No. 4,356,011, issued to C. E. Day et al. on Oct. 26, 1982, the filter bags disclosed include a plurality of alternating rows of filamentary stays or span stitching spaced across the filter bag width to shape the bag into a plurality of communicating tube-like sections. Such an arrangement and like arrangements also have been comparatively complex and expensive in manufacture, maintenance and operation and have tended to limit maximum usage of filtering area and also have tended to interfere with uniform fluid flow through the filtering area for the treated fluid streams. In U.S. Pat. No. 5,215,609, issued to S. L. Sanders on Jun. 1, 1993, a comparatively complex and expensive ultrasonic welding method for forming and manufacturing bag filters is disclosed with no particular consideration being given to adjacent filter bag interference and the inflation limitation of each of the filter bags. In U.S. Pat. Nos. 6,258,142 and 6,159,316, both issued to Holt et al., respectively teach a gas filter element and method of making where the filter element has two side walls joined along three edges to define a pocket. Parallel partitions bridge the opposite side walls with a short length portion of one edge of the partition adjacent the open inlet end not joined to the adjacent sidewall. Also taught is having an elongated slit in the upstream end portion of the partition to provide two flaps. Even though the filter bag has an expandable inlet for installing in a frame, the flap or flaps formed extend angularly from the partition and hence tend to flutter in the moving fluid causing resistance to fluid flow and damage to the filter bag assembly.

What is needed is a filter bag assembly that permits flexure of the front or upstream end of the pocket or filter bag so that it may easily be mounted in a filter header frame where the filter bag has a lesser resistance to fluid flow and a greater resistance to damage while allowing efficient manufacture such as by existing equipment and means.

### SUMMARY OF THE INVENTION

The present invention provides a unique and novel filter bag arrangement which can be efficiently and effectively manufactured and can efficiently be placed in a header frame to remove filter particulate matter from a particulate laden fluid stream to be treated with a minimum of pressure drop and have increased durability. Various other features of the present invention will become obvious to one skilled in the art upon reading the disclosure set forth herein.

More particularly, the present invention provides a fluid filter assembly having a header frame and a plurality of installed filter bags for removing particulate contaminants from a contaminant laden fluid stream comprising: a plurality of sheath-like filter bags each including a pair of longitudinally extending fluid pervious filter panels positioned in opposed relation to form filter bag sides therebetween, the filter bag formed with the opposed filter panels including an open upstream end and a spaced downstream end, the opposed longitudinally extending fluid pervious filter panels being substantially connected together by joiners in strip-like form with a longitudinal body portion arranged to extend substantially perpendicular between the longitudinally extending opposed filter panels and fastened on opposite edges of the longitudinal sides of the body portion to the opposed panels from the downstream end to joiner separation points a preselected distance from the upstream end allowing easy installation in a header frame, the joiners being of preselective breadth extending between opposed filter panels serving to shape and restrain outward inflation of the sheath-like filter bag with minimal interference with a fluid stream passing through the filter panels of the filter bag. In addition, the present invention provides a method of forming a fluid filter assembly comprising: continuously feeding preselectively sized sheets of filter media from a media supply zone; guiding the sheets of filter media in spaced opposed filter panel filter bag forming relation to a fastening zone; continuously feeding at least one preselectively sized strip-like joiner between the spaced opposed filter panels; skip welding the opposed longitudinal sides of the strip-like joiner to the opposed filter panels from the downstream end to joiner separation points a preselected distance from the upstream end to provide at least one longitudinal extendible body portion therebetween to limit inflation of the filter bag formed by the filter panels; and welding the side edges and downstream edge of the spaced opposed filter panels.

It is to be understood that various changes can be made by one skilled in the art in one or more of the several parts of the above-described filter bag and assembly and in one or more of the several steps of the above method of forming a fluid filter bag without departing from the scope or spirit of the present invention.

### BRIEF DESCRIPTION OF THE DRAWINGS

Referring to the drawings which disclose several embodiments of the inventive filter bag assembly, arrangement, method of making, and modifications thereto. The figures disclose several embodiments of the present invention and are not to be interpreted as limiting the scope of the instant invention.

FIG. 1 is an isometric view of an embodiment of the inventive filter bag assembly comprising a flow-through housing structure having a plurality of the inventive filter bags;

FIG. 2 is a cutaway isometric view of an embodiment of the inventive filter bag showing joiners having a removed end portion;

FIG. 2a is a cutaway isometric view of an alternative embodiment of the inventive filter bag showing joiners having a perforation between joiner separation points;

FIG. 3 is a cutaway isometric view of an alternative embodiment of the inventive filter bag showing joiners having a folded back end portion; and

FIG. 4 is a schematic arrangement of a method of forming the inventive filter bag as is disclosed in FIGS. 1-3.

### DETAILED DESCRIPTION

The instant invention is of a pocket filter having joiners extending between opposing filter panels from the downstream end to a preselected distance from the upstream end, optionally a transverse perforation is made in the joiner at a preselected distance from the upstream end allowing easy removal of an end portion of the joiner near the upstream end of the filter bag.

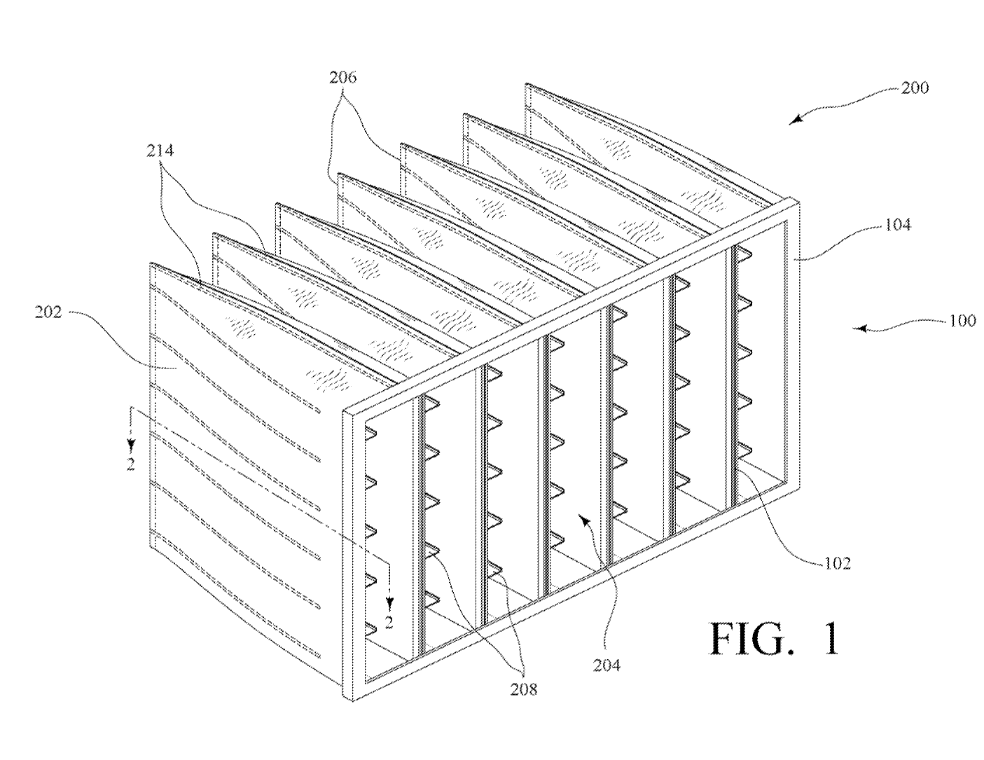

Referring to FIGS. 1-4 of the drawings, the inventive filter bag, assembly, and method of making a filter bag for removing particulate contaminants from a contaminant laden fluid stream, such as a dirty air or other gas stream or even a contaminated liquid when an appropriate filter medium is employed, is disclosed.

Referring to FIG. 1 of the drawings, a plurality of assembled filter bags 200 are shown disposed in a flow-through housing 104 of a suitably selected rigid material such as metal or plastic. Filter bags 200 have expanded upstream ends 204 being fastened in a suitable fashion to each other, flow through housing 104, and/or to spaced parallel header strips 102 extending between opposing sides of flow-through housing 104. The assembled combination of filter bags 200, housing 104, and header strips 102 form filter bag assembly 100. Filter bags 200 each have a pair of opposing filter panels 202 joined together at side edges 214 and the downstream edges 206. Each filter bag 200 has at least one joiner 208 attached to and extending substantially perpendicular between opposing filter panels 202.

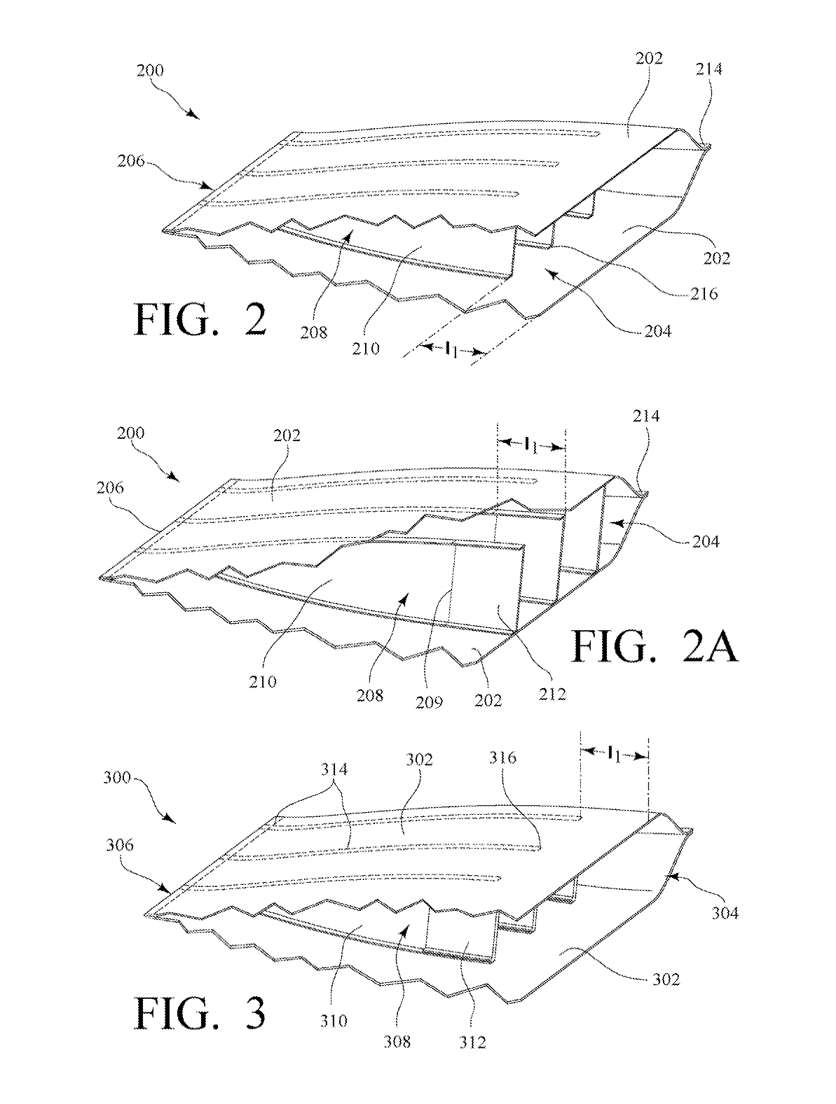

Referring to FIGS. 2 and 2A, a cutaway of the sheath-like pocket filter bag 200 is shown. The filter bag 200 includes a pair of longitudinally extending fluid pervious filter panels 202 positioned in opposed relation to form the filter bag sides to include an open upstream end 204 and a spaced downstream edge 206. In this advantageous embodiment of the invention, the downstream end edges 206 of opposing filter panels 202, like the longitudinally extending side edges 214 of filter panels 202, can be sealed closed.

Opposed fluid pervious filter panels 202 are substantially joined together by at least one spaced strip-like joiner 208 which can be in the form of segments of longitudinally extending continuous joiners 208 where the segments include body segments 210 (FIG. 2) and optionally end segments 212 (FIG. 2A). Body segments 210 extend from downstream end edges 206 to joiner separation points 216 at distance l₁ from upstream end 204. Optional end segments 212 extend from body segment 210 to upstream end 204, thus having a length of l₁. l₁ is advantageously in a range of about 0.1 to 10 inches. More advantageously, l₁ is in a range of approximately 0.5 to 5 inches and most advantageously l₁ is about 2 inches. Optionally, a perforation 209 may be made in joiner 208 laterally extending between panels 202 at a distance l₁ from upstream end 204 (FIG. 2A). This perforation allows for the optional easy removal of end segment 212 resulting in the joiner 208 having only a body segment 210 extending to joiner separation points 216 on each of the opposed filter panels 202, as shown in FIG. 2. Such an embodiment is advantageous since there is no flap formed by end segment 212 thus reducing resistance to air flow through filter bag 200.

The individual segments of joiners 208 can be formed from a suitably strong flexible or substantially rigid filter material of advantageously consistent preselected breadth to present a pocket filter bag 200 having a substantially consistent preselected spacing between opposing filter panels 202 when filter bag 200 is inflated. Advantageously, spaced, strip-like joiners 208 are of fusible material with body portions 210 extending between filter panels 202 and with opposite edges preferably joined by fusion or welding, such as sonic welding, to the opposite facing filter panels 202.

Joiners 208 shape and form filter bags 200, and are arranged in spaced substantially parallel rows to include spaced body portions 210 and optionally end portions 212. Body portions 210 are fastened to opposite filter panels 202 in successively linear offset relation with corresponding body portions 210 of each spaced longitudinally extending joiner 208 being of like size and geometry with the other body portions 210 of the other offset joiners 208 between opposed filter panels 202, and extending from the downstream end 206 of filter bag 200 toward upstream end 204 of filter bag 200; in this manner the opposed filter panels 202 of sheath-like filter bags 200 form a filter bag having a substantially consistent spacing between panels 202 when inflated. When inflated by a fluid stream, fastened body portions 210 of joiners 208 limit or restrain the amount of filter bag 200 inflation without substantially restricting fluid flow of the stream to be treated. Having body portions 210 welded from downstream end 206 to joiner separation points 216 at a preselected distance, l₁ from upstream end 204, permits the separation of panels 202 at upstream end 204 for mounting in a filter frame 104 as shown in FIG. 1. Advantageously, filter panels 202 and joiners 208 are comprised of a supple cloth like filtering material allowing filter bags 200 to collapse in the absence of fluid flow therethrough.

It is to be understood that continuous joiners 208 can be laterally spaced in between panels 202 and that fastening opposed longitudinal edges of body segments 210 to opposed filter panels 202 can be accomplished in a number of ways such as by fusion, welding, or other fastening mechanisms known to persons of ordinary skill in the art. Skip welding is the preferable method since this way of fastening offers efficient incorporation with existing production apparatus and methods. Side edges 214 and the downstream edges 206 of filter panels 202 can be joined and closed by fusion, welding, or other suitable edge joining means as well.

Fluid pervious filter panels 202 forming filter bags 200 extend lengthwise in a range of approximately two (2) inches to forty (40) inches and in width in a range of approximately six (6) inches to thirty-six (36) inches, with body portions 210 of joiners 208 longitudinally extending from downstream edge 206 to a separation point 216 a distance of l₁ from upstream end 204. l₁ is in a range of approximately 0.1 inches to 10 inches from upstream end 204. Joiners 208 have body portions 210 advantageously comprised of a fusible filtering material and can be formed in a single or multiple layer form from any one of a number of suitable filter materials such as spun-bond, wet-laid, dry-laid, spun-lace, or any of a number of other fusible materials utilized for filtering purposes and advantageously may be provided in thicknesses in the range of five thousandths (0.005) of an inch to eight one hundredths (0.08) inch.

FIG. 3 shows a cutaway of another embodiment of a sheath-like pocket filter bag 300. The filter bag or pocket filter 300 includes a pair of longitudinally extending fluid pervious filter panels 302 positioned in opposed relation to form the filter bag sides and forming an open upstream end 304 and a spaced downstream edge 306. In this embodiment of the invention, the downstream end edges 306 of opposing filter panels 302, can be sealed closed. Opposed fluid pervious filter panels 302 are substantially joined together by at least one spaced strip-like joiner 308, which as shown is in the form of segmented longitudinally extending continuous joiners 308 where the segments include body segments 310 and end segments 312. Body segments 310 extend from downstream end edges 306 to a point l₁ from upstream end 304. End segments 312 append from body segment 310 and are folded back in a mating relationship with body segment 310. This configuration of joiner 308 is obtained by skip welding opposed longitudinal edges of joiners 308 to their respective filter panels 302.

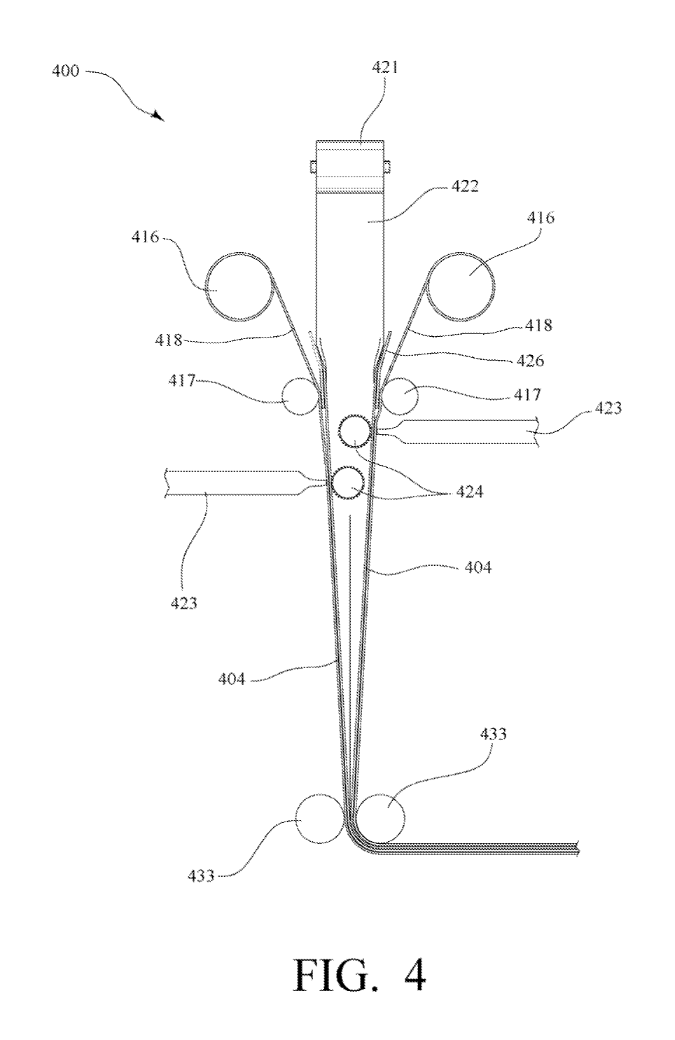

Referring to FIG. 4 of the drawings, an apparatus for forming the above-described filter bags is schematically disclosed. A filter bag forming machine 400 includes a spaced pair of filter medium rotatable support rollers 416 and a spaced pair of rotatable guide rollers 417, so positioned with respect to each other as to continuously guide sheets of filter medium 418 fed by means of pinch rollers 433 to form spaced opposed filter bag forming panels 404. At least one strip joiner material roller 421 is transversely positioned between the spaced filter medium support rollers 416 and spaced guide rollers 417 and by means of pinch rollers 433 continuously feed a strip of joiner material 422, advantageously of a fusible material. Fastening of joiner material 422 to opposed fed sheets of filter medium 418 is accomplished with a pair of laterally positioned sonic skip welders 423 positioned in a spaced, facing or opposed direction adjacent the outer faces of the spaced opposed filter bag forming filter panels 404. Substantially cylindrical anvils 424 having a dotted pattern on the cylindrical surfaces are positioned adjacent the inner surfaces of the spaced opposed filter bag forming panels 404, substantially opposite skip welders 423. Opposing edge guides 426 fold opposed outer edges of joiner material 422 as they approach the cylindrical surface of anvils 424 which serve to urge opposed outer edges of joiner material 422 adjacent filter bag panels 404 at a point in alignment with the laterally positioned sonic skip welders 423. With this arrangement, the spaced opposed laterally positioned sonic skip welders 423, anvils 424 and, edge guides 426 serve to intermittently fuse outer edges of joiner material 422 to the adjacent facing filter panels 404.

In carrying out the inventive method of FIG. 4, sheets of fusible media 418 are fed by pinch rollers 433 from spaced supply zones 416 in spaced opposed filter panel filter bag forming relation. At substantially the same time at least one preselectively spaced sheet of joiner material 422 made of a fusible filter material is fed from joiner supply 421 by pinch rollers 433 between the spaced opposed filter panels to the bag forming and fastening zone. The outer longitudinal edges of joiner material 422 are skip welded or intermittently sonically fused to the opposed filter panels 404 in longitudinally extending relation with each adjacently spaced joiner sheet 422 being intermittently fused to opposed filter panels 404, the adjacent joiners 422 being preselectively spaced. The joined and fused panels are then sonically fuse sealed along the opposed side edges and the downstream edge of the bag. The completed filter bag is then severed from the continuously fed sheets and fastener zone by suitable bag separator or cut-off mechanisms.

From the above, it can be seen that a unique filter bag arrangement and filter bag forming method herein provided is straightforward, economical and efficient in manufacture and assembly utilizing existing production apparatus. The method utilizes a minimum of assembly steps to produce filter bags, which present a minimum of pressure drop to a particulate laden fluid stream to be filtered.

The pocket or bag filter of the instant invention is comprised of two opposed fluid pervious filter panels connected together at three edges and by spaced parallel rows of joiners longitudinally extending from upstream end and extending toward a downstream end. The joiners may be substantially rectangular in shape and formed from a suitably strong flexible or substantially rigid filter material. The joiners are joined by intermittent fusion or ultrasonic skip welding to the opposite facing filter panels from the downstream end to near the upstream end. The joiner may be perforated near the upstream end thus allowing for easy removal of a section of the joiner near the upstream end. Such a design allows for easy separation of filter panels thus easy installation into a filter header frame.

The present invention also provides a method of forming a fluid filter assembly comprising: continuously feeding preselectively sized sheets of filter media from a media supply zone; guiding the sheets of filter media in spaced opposed filter panel filter bag forming relation to a fastening zone; continuously feeding at least one preselectively sized strip-like joiner between the spaced opposed filter panels; aligning opposed outer edges of the joiner adjacent each opposed sheets of filter media; skip welding the opposed longitudinal sides of the strip-like joiner to the opposed filter panels from the downstream end to a preselected distance from the upstream end to provide at least one longitudinal extendible body portion therebetween to limit inflation of the filter bag formed by the filter panels; and welding the side edges and downstream edge of the spaced opposed filter panels.

1. A fluid filter bag comprising:
a pair of fluid pervious filter panels positioned in spaced opposed relation and joined together at side edges and a downstream end to form filter bag sides therebetween, said filter bag formed with said opposed spaced filter panels including an open upstream end opposite said downstream end,
at least one joiner in strip form arranged to extend between said spaced opposed filter panels and fastened on opposite edges of said joiner to said opposed panels from said downstream end to at least 0.1 inches from said upstream end.

2. The fluid filter bag of claim 1 wherein said pair of fluid pervious filter panels and said at least one joiner are comprised of a supple material suitable to collapse in the absence of a fluid flow therethrough.

3. The fluid filter bag of claim 1, said joiner being fastened to said opposed filter panels by skip welding.

4. The fluid filter bag of claim 1 wherein said at least one joiner is substantially transversely perforated forming a removable flap.

5. The fluid filter bag of claim 4 wherein said at least one joiner has said removable flap removed.

6. The fluid filter bag of claim 1 wherein said separation points for each opposite edge of each of said at least one joiner is substantial equidistant from said upstream end.

7. The fluid filter bag of claim 1, said filter bag fluid filter panels being fastened along opposed side edges and downstream edge thereof

8. The fluid filter bag of claim 1 wherein said filter bag panels and said at least one joiner being of a preselected fusible material.

9. The fluid filter bag of claim 1, wherein said filter bag panels being of a preselected synthetic fibrous material.

10. The fluid filter bag of claim 1, said spaced fluid pervious filter panels extend in a range of approximately two (2) inches to forty (40) inches and in width in a range of approximately six (6) inches to thirty-six (36) inches with said joiners having a joiner separation point in a range of approximately 0.1 inches to 5 inches from said upstream end.

11. The fluid filter bag of claim 1, said at least one joiner advantageously being of fusible material in the range of zero point zero zero five (0.005) to zero point zero eight (0.08) inches thickness.

12. A fluid filter assembly for removing particulate contaminants from a contaminant laden gas stream comprising: at least one sheath filter bag including a pair of longitudinally extending fluid pervious filter panels positioned in spaced opposed relation to form filter bag sides therebetween, said filter bag formed with said opposed filter panels including an open upstream end and a spaced downstream end, said spaced opposed longitudinally extending fluid pervious filter panels being connected together by spaced parallel rows of longitudinally extending joiners, each of said joiners being of fusible filter material and having a body portion being joined at opposite side edges to said spaced opposed facing panels with corresponding body portions of each joiner being in agreement in size and geometry and with said body portions of said joiners being in length between said opposed filter panels from said downstream end of said filter bag toward said upstream end of said filter bag whereby said length of said body portion is less than the length of said spaced opposed filter panels of said sheath filter bag forming a filter bag with an expandable upstream end.

13. The fluid filter assembly of claim 12 wherein said length of said body portion of said joiners is in a range of about 0.1 to 5 inches less than said length of said spaced opposed filter panels.

14. The fluid filter assembly of claim 12 wherein said length of said body portion of said joiners is in a range of about 0.25 to 2 inches less than said length of said spaced opposed filter panels.

15. The fluid filter assembly of claim 12 wherein said length of said body portion of said joiners is about 0.5 inches less than said length of said spaced opposed filter panels.

16. The fluid filter assembly of claim 12 wherein said expandable upstream end of each of said at least one sheath filter bag is disposed in a flow-through housing.

17. The fluid filter assembly of claim 12 wherein said joiners are skip welded to said opposed filter panels.

18. A method of forming a fluid filter assembly comprising: continuously feeding pre-selectively sized spaced sheets of filter media from a media supply zone; guiding said sheets of filter media in spaced opposed filter panel filter bag forming relation to a fastening zone; continuously feeding at least one preselectively sized joiner in a substantially perpendicular orientation between said spaced opposed filter panels from a joiner supply zone; folding outer opposed edges of said joiner substantially parallel to said filter panels; and fastening said opposed edges of said joiner to said opposed filter panels from a downstream end to a preselected distance from an upstream end to provide at least one body portion therebetween to limit inflation of said filter bag formed by said spaced filter panels; and sealing at least the side edges of said spaced, opposed filter panels of said filter bag.

19. The method of claim 18, wherein said fastening said opposed edges of said joiner is accomplished by skip welding.

20. The method of claim 18, wherein said filter bag side edges and downstream edge are fastened by sonic fusion.

21. The method of claim 18, wherein a plurality of spaced adjacent joiners are in the form of flexible filter material are fed between said spaced filter panels and are each fastened to said spaced filter panels to provide a plurality of substantially equidistantly spaced body portions, said body portions of each of said adjacent joiners corresponding in breadth between said spaced opposed filter bag filter panels.
